(19) United States
(12) Patent Application Publication
(10) Pub. No.: US 2013/0284831 A1
(43) Pub. Date: Oct. 31, 2013

(54) PORTABLE PARTICLE SPREADING DEVICE

(71) Applicant: Warren Darnell, Richmond, VA (US)

(72) Inventor: Warren Darnell, Richmond, VA (US)

(21) Appl. No.: 13/865,182

(22) Filed: Apr. 17, 2013

Related U.S. Application Data
(60) Provisional application No. 61/640,702, filed on Apr. 30, 2012.

(51) Int. Cl. A01C 15/00

(52) U.S. Cl. CPC E01H 10/00; A01C 7/02
USPC 239/650

(57) ABSTRACT

A portable hand-held device for spreading particulate matter such as rock salt or seed. The device includes a bucket-like body of one or two piece construction with apertures positioned at specific locations so as to control the flow and distribution of salt or seed during operation. The device incorporates an inset disk which further increases the efficiency of the device.

This application claims priority from U.S. Provisional Patent application No. 61/640,702 filed on Apr. 30, 2012.

### FIELD OF THE INVENTION

The present invention relates to portable devices for spreading particulate material, and, more specifically, a hand-held portable apparatus to be used to spread granular ice melting products on hard surfaces.

### BACKGROUND OF THE INVENTION

In many geographic locations, snow and ice frequently accumulate on walkways, sidewalks, and other similar ground surfaces during the winter months. This snow and ice can create hazardous conditions which lead to accidents and injury for pedestrians crossing such surfaces. Mechanical clearing is often the first technique used to eliminate such deposits. Unfortunately, mechanical clearing of ice requires considerably more effort than the clearing of snow. Further, ice removal by mechanical methods may lead to extensive damage of the ground surface. De-icing is frequently carried out through the application of salt or analogous material to the ground surface. Halite, also known as rock salt, has traditionally been used to provide surface de-icing. Other, more environmentally friendly, de-icing substances, such as calcium magnesium acetate, are also frequently used.

Rock salt and similar de-icing products are typically sold in loose particulate form in 10, 25 or 50 pound plastic bags. This salt is frequently applied to the iced surface by hand. A user might use his or her hand or a small shovel, a scoop, or even a plastic cup to spread the salt on the surface. In such cases, the user would be forced to return to the bag to refill the shovel, scoop, or other spreading device. Alternatively, the user could fill a second container with the salt, carry the second container on his person and retrieve the salt from this container. Regardless, retrieval of the salt from the bag can be time consuming and can result in spillage of salt in storage areas and during transport. Further, the application of salt by these methods frequently results in an uneven distribution of the salt on the iced surface. Uneven distribution can result in excess salt in some areas, leading to waste of such salt, or inadequate salt in other areas, which may not be sufficient to effectively melt the ice in that area. In addition, the salt can be caustic in nature, so application of salt by hand is generally not recommended. The present invention solves the aforementioned problems and provides a simple and effective method for distributing salt onto iced surfaces

### OBJECT OF THE INVENTION

It is an object of the invention to provide a portable hand-held salt or seed spreading device that is easily carried and operated. It is a further object of the invention to provide such a device that can store such salt without leaking or spilling salt in inappropriate locations. Finally, it is an object of the invention to create a portable hand-held salt spreading device that can be manufactured quickly at a low cost.

### SUMMARY OF THE INVENTION

The present invention discloses a portable hand-held particulate matter spreader. The spreader consists of a one or two piece bucket which stores salt, seed or any such material. The bucket includes a spacing disk and a plurality of apertures located in such a fashion as to assist in controlling the location and amount of particulate matter delivered to a target area.

### BRIEF DESCRIPTION OF THE DRAWINGS

FIG. 1 is a side view of a first embodiment of the invention.

FIG. 2 is an alternate side view of a first embodiment of the invention.

FIG. 3 is a rear view of a first embodiment of the invention.

FIG. 4 is a top view of a first embodiment of the invention.

FIG. 5 is a perspective view of the interior disk.

FIG. 6 is a cut-away side view of a first embodiment of the invention.

FIG. 7 is an alternate cut-away side view of a first embodiment of the invention.

FIG. 8 is a second alternate cut-away side view of a first embodiment of the invention.

FIG. 9 is a side view of a second embodiment of the invention.

FIG. 10 is an alternate side view of a first embodiment of the invention.

FIG. 11 is a rear view of a first embodiment of the invention.

FIG. 12 is a top view of a second embodiment of the invention.

FIG. 13 is a perspective view of the bottom portion of a second embodiment of the invention.

FIG. 14 is a cut-away side view of a second embodiment of the invention.

FIG. 15 is a top view of a second embodiment of the invention.

FIG. 16 is a transparent side-view of a second embodiment of the invention.

### DETAILED DESCRIPTION

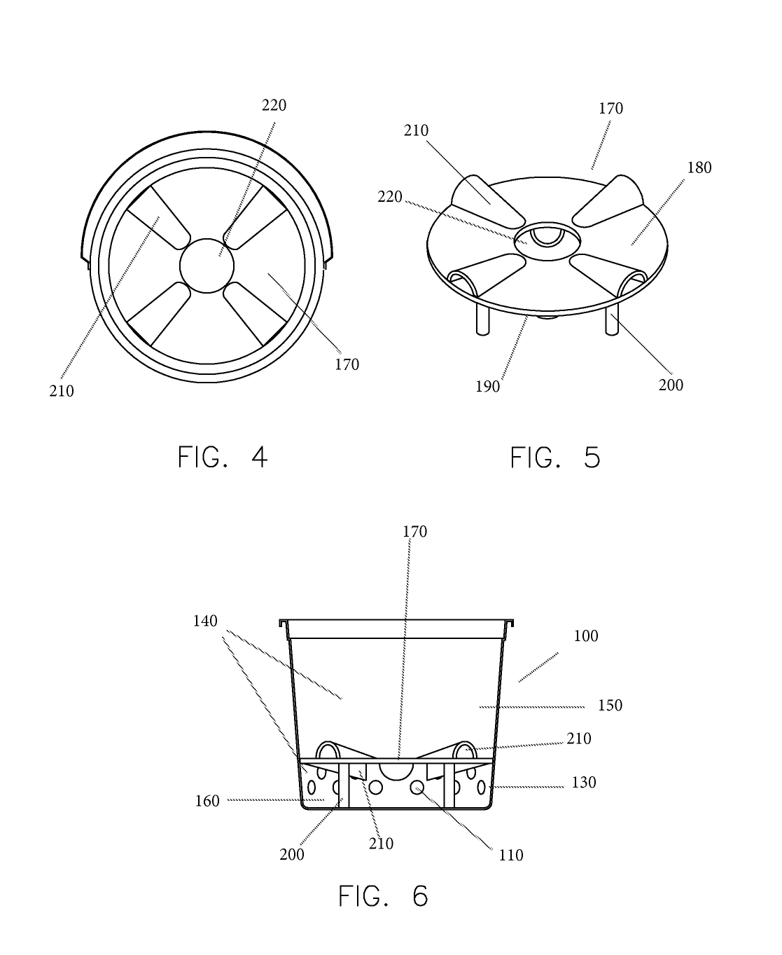

The invention consists of a container in which the salt is stored and from which it is dispensed. In a preferred embodiment, the container is a circular bucket 100 having an open top as seen in FIGS. 1-4. The bucket 100 has a handle attached whereby a user may transport and utilize the device as set forth herein. The bucket 100 also includes a closure element or lid. In the preferred embodiment, the lid is a standard snap on lid as frequently found on plastic buckets of this nature. It will be noted that the lid can be affixed through various fastening means, and, further, may include windows, slides, or any other features for ease of access.

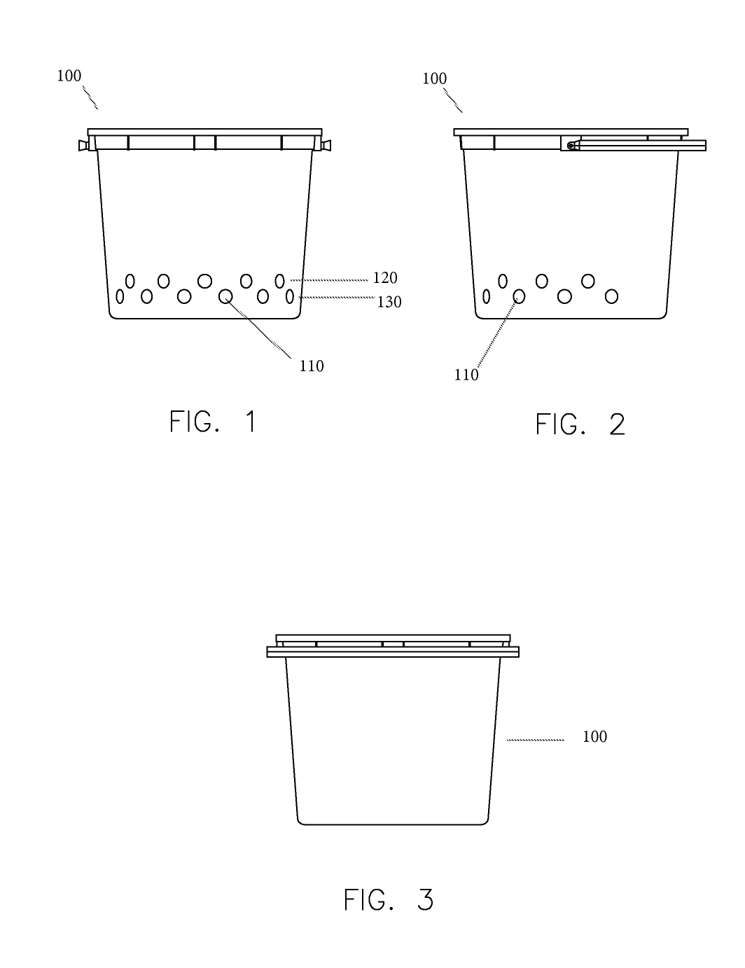

Referring now to FIGS. 1-2, the bucket 100 has a plurality of apertures 110 located proximate to the base. The apertures 110 are generally circular in shape and are located in two rows, one above the other. In a preferred embodiment, the top row 120 consists of nine outlet holes and the bottom row 130 consists of ten outlet holes. The holes do not entirely circumscribe the exterior of the bucket 100. Approximately one-third of the circumference of the bucket is devoid of such apertures, as seen in FIGS. 1-3 (FIG. 1 front view, FIG. 2 side view, and FIG. 3 rear view).

In the preferred embodiment, the holes 110 are approximately 1½ inches (3.81 cm) apart. It will be recognized that the apertures need not be perfectly round in shape. Further the number of holes 110 may vary slightly depending on the size of the bucket or other such factors. In the preferred embodiment, the holes are positioned such that the top row of holes is offset from the bottom row of holes, as seen in FIG. 1. In alternate embodiments, the holes may be aligned in a more parallel fashion.

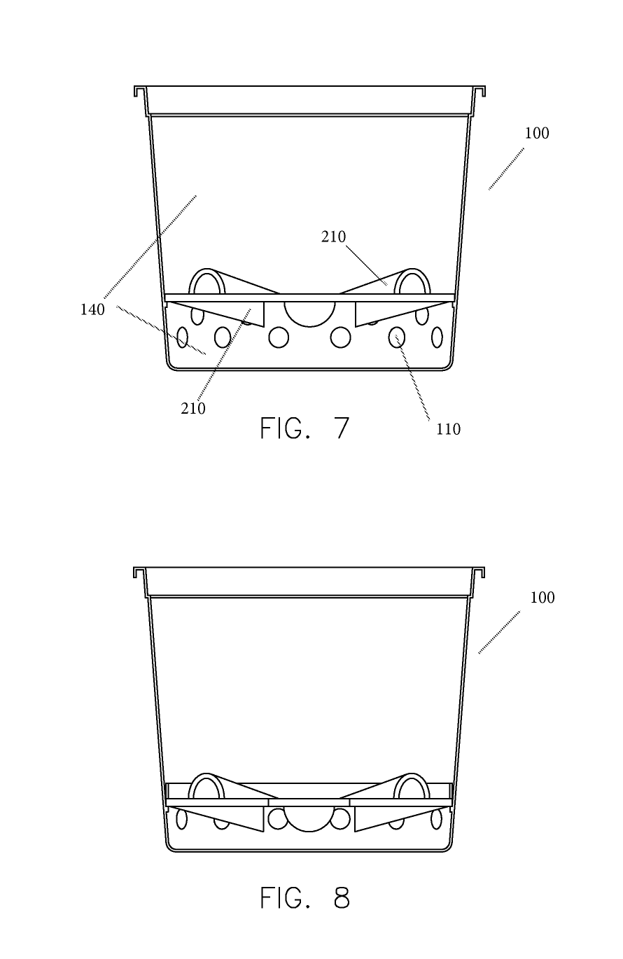

The interior of the bucket 100 defines a multi-cavity interior space 140 for storage and distribution of the salt. Referring now to the cross-sectional views shown in FIGS. 7-8, the interior space 140 comprises an upper storage cavity 150 and a lower distribution cavity 160. The cavities are divided by a removable spacing disk 170. The upper cavity is the larger of the two cavities and comprises at least two-thirds of the total interior space. The lower distribution cavity communicates with the apertures 110 which are located entirely within the area bounding the lower cavity. In the preferred embodiment, the walls of the bucket 100 are angled slightly such that diameter of the top opening is greater than the diameter of the base. This angling facilitates the movement of salt or seed through the device.

The inset disk 170, shown in FIG. 5, is circular in shape and includes a center hole which provides a passageway 220 for interconnection of the upper storage cavity and the lower distribution cavity. The top surface of the disk 180 forms the bottom of the storage cavity and the bottom surface of the disk 190 forms the upper surface of the distribution cavity.

In a first embodiment, shown in FIG. 6, the inset disk 170 includes a plurality of support members 200, or legs, which extend from the bottom surface of the disk. The legs 200 of the disk rest upon the bucket bottom and hold the disk 170 in its appropriate location within the interior space. In an alternate embodiment, the disk does not include legs. In such an embodiment, a shoulder or lip extends outward from at least a portion of the interior wall of the bucket 100, as seen in FIGS. 7 and 8. The insert would then rest upon the shoulder or lip. It will also be noted that the insert need not be a separate component but rather may be of unitary construction with the bucket.

The disk includes a plurality of projections 210 on both its top and bottom surfaces. Both surfaces include a plurality of projections as seen in FIG. 5. Each projection 210 originates from the surface of the disk and protrudes into the respective upper or lower cavity. While the form of the projection 210 may vary slightly, each projection on the top surface comprises a half-circle or arc which is widest at a point closest to the bucket wall and tapers as the projection extends toward the center hole 220. The form of projection on the bottom varies slightly from the projections on the top. The bottom projections are rounded fin-like structures and begin at the periphery of the disk. Each forms what is essentially a bisected triangle extending into the lower cavity. FIG. 5 best illustrates the design of a preferred embodiment of such projections.

On the top surface 180 of the inset, the projections 210 serve two principal functions. First, the projections prevent the portion of the salt at the bottom of the bucket from becoming overly compacted. Second, the projections assist in agitating the salt and directing it towards the center hole for delivery when in use. The preferred embodiment utilizes the arc-shaped or rounded-shape projection as such a design is more effective at providing the foregoing benefits (as opposed to other shapes such as fins or flat plane shapes). On the bottom surface 190 of the inset, the projections assist in directing the salt through the outlet holes and out of the device when the device is in operation.

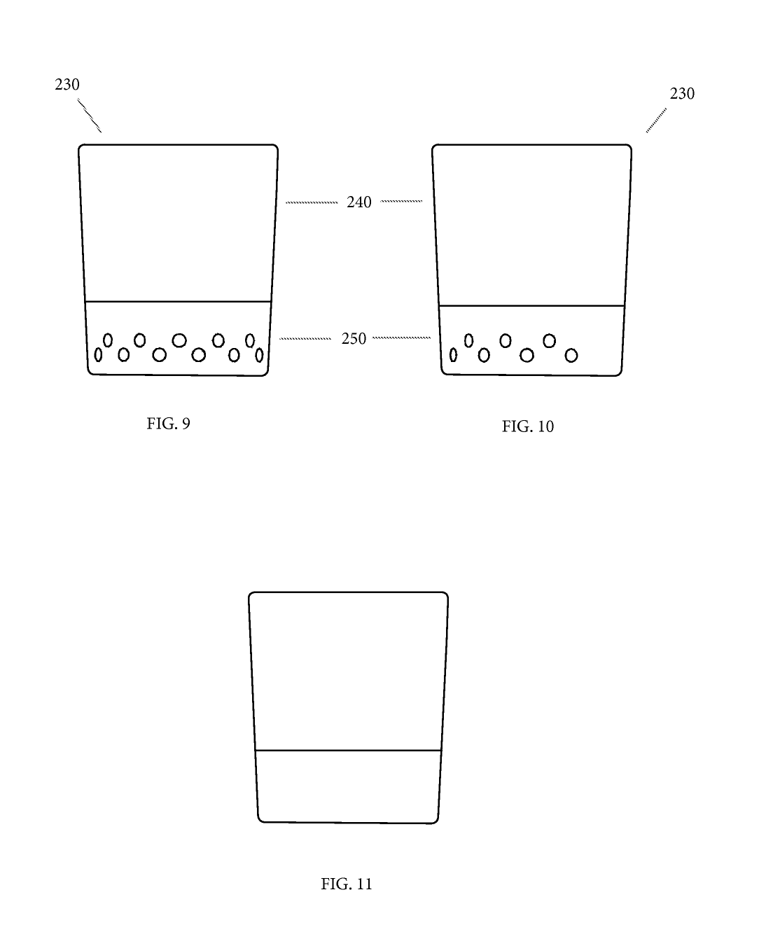

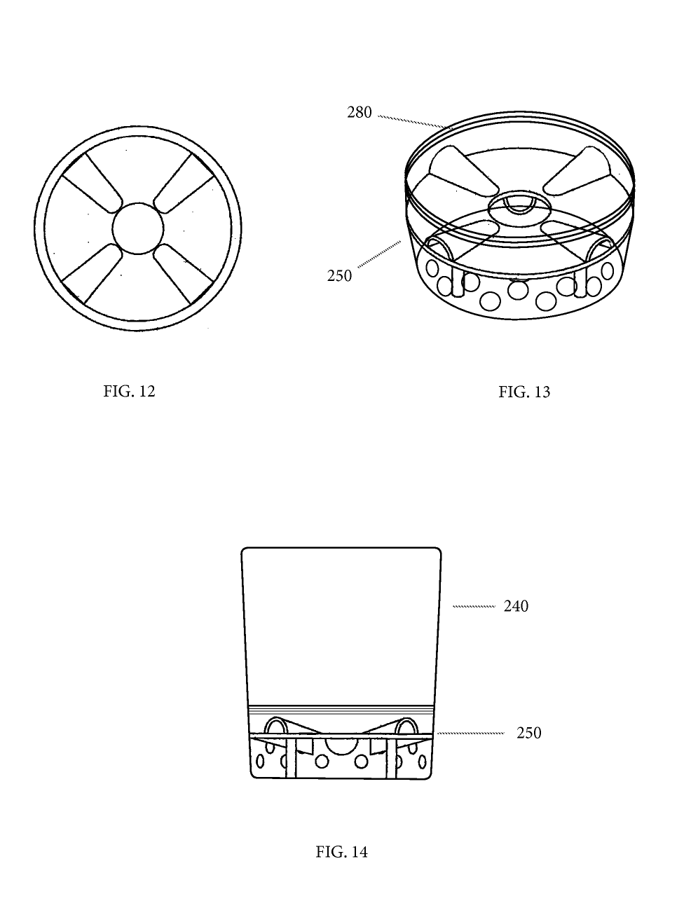

A second embodiment is disclosed in FIGS. 9-16. In this embodiment, the device 230 is comprised of two sections, an upper portion 240 and a bottom portion 250. In this embodiment, the inset disk is integral with the bottom portion of the bucket 250 as best seen in FIG. 13. The bottom portion of the bucket 250, therefore, includes the distribution cavity 260 and the apertures 270. The upper portion 240 of the bucket is, in essence, a circular body which, when joined with the bottom portion 250, forms the upper cavity. As opposed to the first embodiment, this second embodiment is composed of only two elements. This results in a substantial reduction in manufacturing costs.

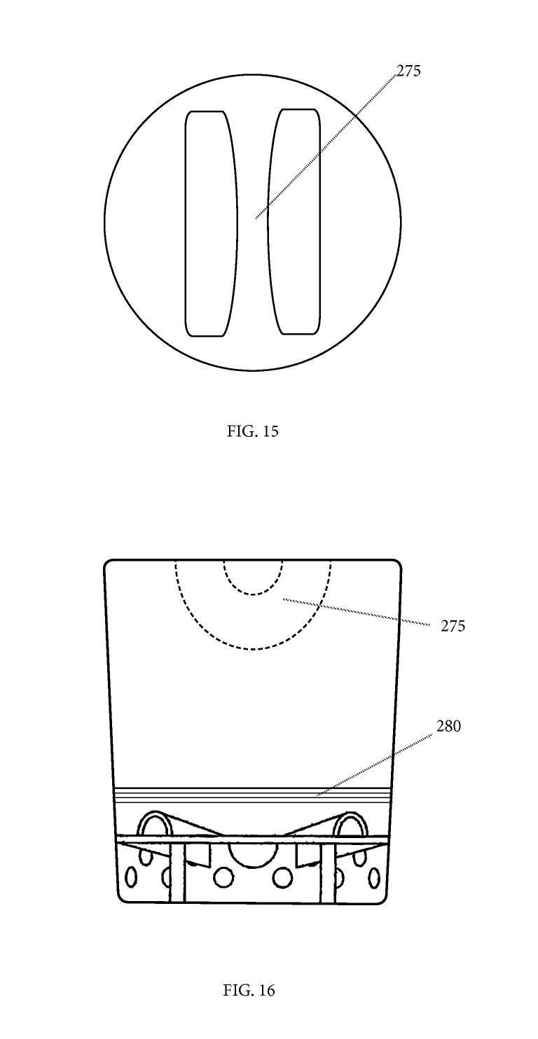

Referring now to FIGS. 15 and 16, the upper portion of the bucket includes a handle or handles 275 which is/are integral with the construction of the upper portion. The handles 275 extend into the space within the upper portion and do not extend beyond this area. The handles can be made to extend above the horizontal plane of the top opening on the upper portion if no lid is used. The second embodiment could be used with or without a lid. In a preferred embodiment, no lid would be used. It will be noted that this handle configuration can be used on the first embodiment and, further, that the handle configuration of the first embodiment may be used in the second embodiment.

The bottom portion of the second embodiment includes a means of attachment to the upper portion. As shown in FIGS. 13 and 14, the preferred means of attachment is through the use of a threaded connection 280 between the two elements. Instead of threads, it will be recognized that the elements may be snapped together or may use any similar connection means which offers the same qualities and benefits of the threaded connection.

The bucket and associated components can be constructed of any material possessing suitable characteristics, i.e., of adequate strength, weight and durability and able to be cost-effectively manufactured. In a preferred embodiment, the bucket would be composed of a plastic, such as polyvinyl chloride.

In operation, a user would use one hand to hold the device by the handle while walking along the area to be covered with salt. The user would then twist his hand/wrist left and right as he walked. The twisting motion causes the bucket to rotate back and forth. The movement of the bucket agitates the salt in the upper storage cavity and causes a portion of such salt to drop into the lower distribution cavity. The rotational movement further causes the salt to be ejected from the distribution cavity via the outlet holes.

The rotational movement results in the distribution of salt in an essentially circular area on the ground or receiving surface. The distribution zone of the salt is not entirely circular in shape since the outlet holes do not extend around the entire periphery of the bucket. Nonetheless, in application, salt distribution is generally sufficiently uniform as long as a user fully walks the area to be covered. While the bucket can be constructed with holes which traverse the entire circumference, the preferred embodiment is not so designed. The design of the preferred embodiment limits the amount of salt which strikes or is deposited on the user while walking along and rotating the device. The preferred embodiment has a distribution zone that allows a user to distribute up to six feet in any direction. The design is such that it assists a user in more evenly and efficiently distributing the salt or other material. As a result, an equivalent amount of salt or other material can be used to cover a greater area when distributed with the instant device. In other words, with regard to rock salt, less salt is required for the same coverage area due to the more efficient distribution of the salt.

The device could be sold pre-filled with salt or other particulate matter. In such cases, a cylindrical insert would be mounted in the bucket prior to initial filling. The insert would extend from the top lip of the bucket, through the upper cavity, pass through the center hole, continue through the lower cavity and ultimately contact the floor of the bucket. After the insert is mounted, the bucket would be filled. The insert insures that the salt remains in the upper cavity. Further, the insert adds support to the bucket so that multiple buckets may be stacked on one another during shipping and transit. The insert would be removed prior to use.

Alternatively, a user may fill or refill the bucket as desired. When filling or refilling a bucket, the majority of the salt poured into the bucket would remain in the upper cavity.

The device need not be used exclusively for rock salt distribution. Indeed, the device can be used to facilitate the storage and distribution of a variety of materials. For instance, the device is well-suited to the distribution of grass seed. The device may also be further modified to such alternate uses.

In the case of grass seed distribution, the legs or shoulder could be set such that the disk sits lower in the bucket. As a result, the disk would be aligned with or below the top row of apertures. The disk may further include a lip or shield which runs along its periphery. The position of the disk, along with the lip or shield, serve to insure that no grass seed passes through the top row of apertures when the device is being operated. This is useful as grass seed is typically distributed at a lower density per square foot than rock salt or other similar materials.

Overall, the device offers numerous benefits and advantages such as:
1. Time savings (a user can carry more salt or other material at one time; further the device permits faster application of the salt or other material);
2. It is more efficient than other currently used methods (less spillage and more even distribution on the receiving surface results in less waste of the salt or other material);
3. It is more effective than other currently used methods (it provides better distribution of the salt or other material on the receiving surface);
4. No need to use one's hand to distribute salt or other material; and
5. It provides optimal storage of the salt or other material (less spillage when not in use; provides more limited access when children and pets are around; and is more aesthetically pleasing than a traditional bag of rock salt sitting on the floor).

While the invention has been described in reference to certain preferred embodiments, it will be readily apparent to one of ordinary skill in the art that certain modifications or variations may be made to the device without departing from the scope of invention described in the foregoing specification.

What is claimed is:

1. A particulate spreading device for dispensing particulate matter on the ground comprising:
A) an essentially bucket shaped hollow body; said body having side walls and a bottom defining an interior space; said body including a plurality of apertures located proximate to said bottom; and
B) an inset disk having upper projections, lower projections, and a passageway therethrough.

2. The device of claim 1 wherein said apertures are arranged in a single row.

3. The device of claim 1 wherein said apertures are arranged in two rows.

4. The device of claim 1 wherein said upper projections of said inset disk are arc-shape in nature.

5. The device of claim 1 wherein said passageway of said inset disk is circular in shape.

6. The device of claim 5 wherein said upper projections originate at said passageway and extend to the walls of said body.

7. The device of claim 6 wherein said upper projections increase in height as they extend towards said walls.

8. The device of claim 1 wherein said inset disk includes at least two legs.

9. The device of claim 1 further including a handle.

10. The device of claim 1 further including a lid.

11. The device of claim 1 wherein said walls include a projection along the circumference of the interior of the bucket.

12. A particulate spreading device for dispensing particulate matter on the ground comprising:
A) a first element; said first element being cylindrical in nature and open at both ends; said first element including a handle at a first end and threads at a second end; and
B) a second element; said second element having a top, having an upper surface and lower surface, and a bottom; said top and bottom defining an interior space; said second element including a plurality of apertures circumscribing at least a portion of the exterior surface of said element; said top including a plurality of projections on said upper surface and on said lower surface and a circular opening in the center;
said first and second elements each being threaded such that the first element is disposed to receive and be removeably connected to said second element.
